(19) United States
(12) Patent Application Publication
(10) Pub. No.: US 2012/0215763 A1
(43) Pub. Date: Aug. 23, 2012

(54) DYNAMIC DISTRIBUTED QUERY EXECUTION OVER HETEROGENEOUS SOURCES

(75) Inventors: Gregory Hughes, Redmond, WA (US); Michael Coulson, Clyde Hill, WA (US); James Terwilliger, Redmond, WA (US); Clemens Szyperski, Redmond, WA (US)

(73) Assignee: MICROSOFT CORPORATION, Redmond, WA (US)

(21) Appl. No.: 13/154,400

(22) Filed: Jun. 6, 2011

Related U.S. Application Data
(60) Provisional application No. 61/444,169, filed on Feb. 18, 2011.

(51) Int. Cl. G06F 17/30

(52) U.S. Cl. 707/718; 707/705; 707/E17.014

(57) ABSTRACT

An execution strategy is generated for a program that interacts with data from multiple heterogeneous data sources during program execution as a function of data source capabilities and costs. Portions of the program can be executed locally and/or remotely with respect to the heterogeneous data sources and results combined.

### CROSS-REFERENCE TO RELATED APPLICATIONS

This application claims the benefit of U.S. Provisional Application No. 61/444,169, filed Feb. 18, 2011, and entitled DYNAMIC DISTRIBUTED QUERY EXECUTION OVER HETEROGENEOUS SOURCES, and is incorporated in its entirety herein by reference.

### BACKGROUND

One of the fundamental problems with traditional database systems is deriving useful information from untold quantities of data fragments that exist in data stores including network-accessible or “cloud” data stores. One obstacle is the fact that data stores are heterogeneous in the sense that they employ differing data models or schema, for example. Data is therefore abundant but useful information is rare.

### SUMMARY

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure generally pertains to optimizing execution of a program that interacts with data from multiple heterogeneous data sources. Each data source can differ in various ways including data representation, data retrieval, transformational capabilities, and performance characteristics, among others. These differences can be exploited to determine an efficient execution strategy for a program. Further yet, analysis can be performed on demand while the program is being executed.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of an efficient program execution system.

FIG. 2 is a block diagram of a representative query-processor component.

FIG. 3 is a block diagram of a representative optimization component.

FIG. 4 is a block diagram of a representative data-provider component.

FIG. 5 is a flow chart diagram of a method of efficiently executing a program that interacts with data from multiple heterogeneous sources.

FIG. 6 is a flow chart diagram of a method of executing a program that interacts with data from multiple heterogeneous sources.

FIG. 7 is a flow chart diagram of a method of cost-based program optimization.

FIG. 8 is a flow chart diagram of a method of cost transformation.

FIG. 9 is a schematic block diagram illustrating a suitable operating environment for aspects of the subject disclosure.

### DETAILED DESCRIPTION

Details below are generally directed toward optimizing execution of a program that interacts with data (e.g., read, write, transform . . . ) with respect to multiple unrelated heterogeneous data sources. Data sources can differ in many ways including data representation, data retrieval, transformational capabilities, and performance characteristics, among others. These differences between data sources can be exploited to determine an efficient execution strategy for an overall program. Further yet, analysis can be performed on demand, or lazily, during program execution.

Related work in the field of data processing includes a structured query language (SQL) distributed query engine and language-integrated queries (LINQ-to-SQL). The SQL distributed query engine performs global analysis of an entire query (not on-demand), is constrained in the set of data sources it can support (e.g., OLE DB—Object Linking and Embedding Database), and uses a one-dimensional model for analyzing external SQL data source capabilities and performance. On the other hand, LINQ-to-SQL is a technology that allows on-demand execution of a program against a SQL server, but does not support heterogeneous data sources and pushes as much of the program to the SQL server as possible without consideration of its effects on overall program performance.

Although not limited thereto, aspects of the subject disclosure can be incorporated with respect to a data integration, or mashup, tool that draws data from multiple heterogeneous data sources (e.g., database, comma-separated values (CSV) files, OData feeds . . . ), transforms the data in non-trivial ways, and publishes the data by several means (e.g., database, OData feed . . . ). The tool can allow non-technical user to create complex data queries in a graphical environment they are familiar with, while making full expressiveness of a query language, for example, available to technical users. Moreover, the tool can encourage interactive building of complex queries or expressions in the presence of a dynamic result previews. To enable this highly interactive functionality, the tool can use optimizations as described further herein to quickly obtain partial preview results, among other things.

Various aspects of the subject disclosure are now described in more detail with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

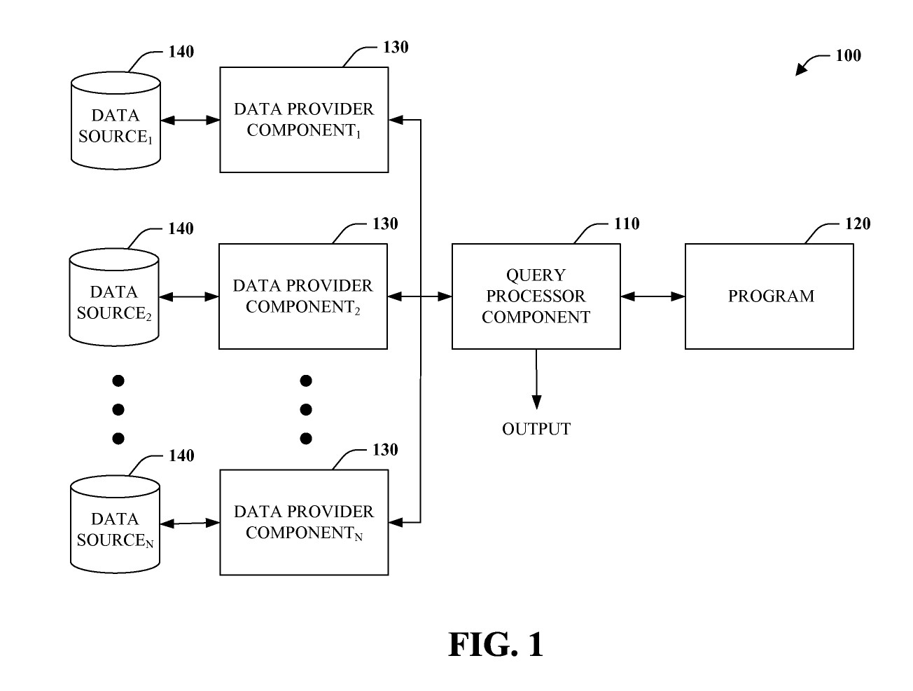

Referring initially to FIG. 1, an efficient program execution system 100 is illustrated. As shown, includes a query processor component 110 communicatively coupled with a program 120 comprising a set of computer-executable instructions that designate a specific action to be performed upon execution (e.g., a computation). Here the program 120 can pertain to data interaction including acquiring, transforming, and generating data, among other things. Although not limited thereto, the program 120 can be specified in a general-purpose functional programming language. Accordingly, the program 120 can specify data interaction in terms of an expression, query expression or simply a query of arbitrary complexity that identifies a set of data to retrieve, for example. As used herein, the program 120 is may be referred to as simply as a query, expression, or query expression to facilitate clarity and understanding. However, the program 120 is not limited to data retrieval actions but, in fact, can specify substantially any type of action, or in other words computation.

The query processor component 110 is configured to execute, or evaluate, the program 120, or query, and return a result. In accordance with an aspect of the disclosure, the query processor component 110 can be configured to federate computation. Stated differently, the program 120 or portions thereof can be distributed for remote execution. Federation enables transparent integration of multiple unrelated and often quite different sources and/or systems to enable uniform interaction. To this end, a program can be segmented into sub-expressions that are submitted for remote execution, after which results from each sub-expression are combined to produce a final result.

Conventional distributed query systems deal with multiple localities of execution but do not appreciate that there may be different capabilities and costs. Such systems differentiate between local and remote execution and allow distribution to multiple locations but assume that the remote places are the same or similar. In the federated model here, such assumptions are relaxed to enable distribution to arbitrary external parties.

The query processor component 110 can interact with a plurality of data provider components 130 (DATA PROVIDER COMPONENT₁-DATA PROVIDER COMPONENT_{N}, where N is a positive integer) and corresponding data sources 140 (DATA SOURCE₁-DATA SOURCE_{N}, where N is a positive integer). The data provider components 130 can be configured to provide a bridge between the query processor component 110 as well as the program 120, and associated data sources 140. In other words, the data provider components 130 can be embodied as a sort of adapter enabling communication with different data sources 140 (e.g., database, data feed, spreadsheet, documents . . . ) as well as different formats of data provided by specific sources (e.g., text, tables, HTML (Hyper Text Markup Language), XML (Extensible Markup Language) . . . ). More specifically, the data provider components 130 can retrieve data from a data source 140 and reconcile changes to data back to a data source 140, among other things.

Moreover, the query processor component 110 can exploit differences between heterogeneous data sources 140, including but not limited to data representations, data retrieval (e.g., full query processor, get mechanism (e.g., read text file) . . . ) and transformation capabilities, as well as performance characteristics, to determine an efficient evaluation scheme, or execution strategy, with respect to the program 120. Further yet, such a determination and associated analysis can be performed on-demand, on parts of the program 120 where there is an opportunity for optimization, while the program is being executed. For example, analysis can be deferred until a result is requested from a particular section of a program and that particular section can potentially be optimized. In other words, dynamic analysis can be performed lazily at run time to determine an optimal execution strategy for the overall program with respect to heterogeneous data sources 140. By deferring analysis, it can be determined that an expression or sub-expression targets a particular data source (e.g., SQL server), and decisions can be made based on costs and capabilities of the particular data source as well as circumstances surrounding interaction with the data source (e.g., network latency).

Execution of a particular execution strategy can produce output representative of operations performed with respect to the heterogeneous data sources 140. In accordance with embodiment, a subset of data can be returned, for instance as a preview of results. For example, rather than returning an entire set of data matching a query, a subset of the data can be returned, such as the first one hundred matching results. Consequently, the amount of data requested, transmitted, and operated over is relatively small, thereby enabling expeditious return of results and subsequent interaction (e.g., drill down).

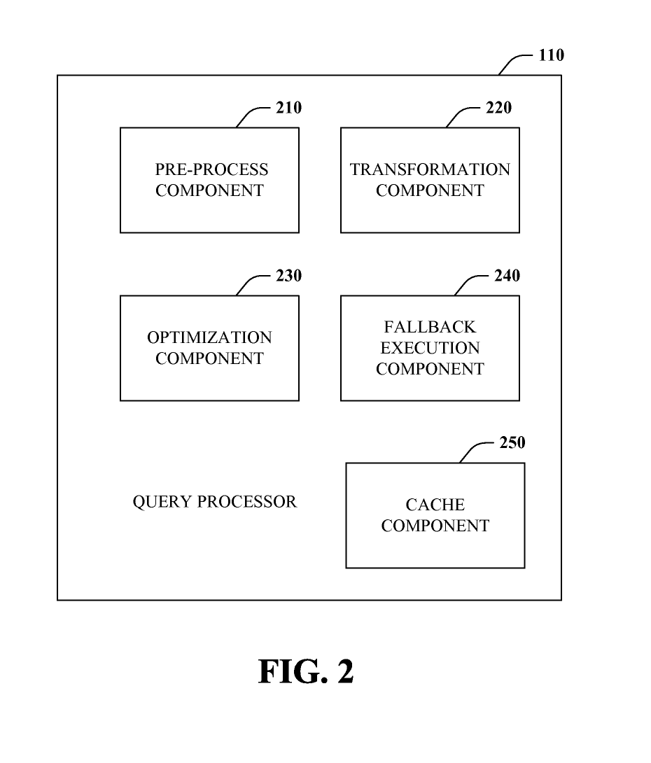

FIG. 2 depicts a representative query-processor component 110 including pre-process component 210, transformation component 220, optimization component 230, and fallback execution component 240. The pre-process component 210 is configured to normalize a program. Stated differently, a program can be mapped from a first form to a second standard form expected and utilized for subsequent processing. For example and in accordance with one embodiment, program expressions, functions, or the like, when invoked, can capture descriptions of themselves and their inputs and send them to the query processor component 110 for execution. Accordingly, the pre-process component 210 can be configured with a set of rules, for instance, to normalize program descriptions, or, in other words, cause the descriptions to conform to a standard comprehensible by the query processor component 110.

Furthermore, the pre-process component can be configured to apply set of general optimizations prior to execution. For example, a filter can be moved to execute prior to a join operation rather than after to reduce the amount of data involved in performing the join. In accordance with one embodiment, normalization and general optimization can be performed in combination. For instance, rules applied to normalize a program can also be constructed to perform general optimizations. Regardless, the end result will be a normalized and generally optimized program that can be further processed.

Transformation component 220 can be configured to solicit information from data provider components 130, for example, regarding whether data sources 140 are capable of executing portions of a program (e.g., sub-expression). In other words, parts of a program that specify acquisition of data from data sources are located and determination is made regarding how much of the program such data sources can understand and execute. Based on received information, the transformation component 220 can transform a program to reflect data source capabilities. For example, portions of the program or expression therein can be combined in a systematic manner to simplify the expression and improve efficient execution. In accordance with one embodiment, the transformation component 220 can perform a fold in a functional programming language (a.k.a. reduce, accumulate, compress, inject) operation with respect to data source capabilities.

The optimization component 230 is configured to select an efficient execution strategy for a program 120 as a function of cost. In brief, a set of optimizations, corresponding to different execution strategies, can be applied to the program to produce equivalent candidate programs. Costs, such as those regarding use of different data sources including latency and other metrics that account for differences between sources, can be applied to the candidate programs. Based on the costs or a specific cost model, one of the candidate programs can be selected as the most efficient, or optimal, program, and thus an execution strategy associated with such optimizations is determined

The query processor component 110 can further include fallback execution component 240 configured to execute all or portions of a program. The fallback execution component 240 can thus be employed to execute pieces of a program that are not handled by other data sources and/or associated systems. Furthermore, the fallback execution component 240 can be considered as a possible target of execution with respect to all or portions of a program initially, for example where it is more efficient to employ the fallback execution component 240 than to distribute execution to another source/system. In other words, the fallback execution component need not be solely a backup execution component used when a program is unable to be executed elsewhere.

Returning briefly to FIG. 1, note that if a data source 140 misrepresents its capabilities or capabilities of a data source 140 differ from a set of capabilities that are expected of the class of source to which the source belongs, a data provider 130 corresponding to the source can be configured to recognize this situation, for instance upon a failed attempt to distribute computation. In such a situation, the data provider component 130 can either incrementally roll back a set of computation until it arrives at a computation of which the data source 140 is capable or fully roll back the computation so that interaction with the data source 140 does not compromise any computation, for example. The choice between incremental and wholesale reverting of delegated computation can be a result of an optimization strategy since data sources 140 respond differently to computation requests that the data source 140 considers inappropriate. For example, a data source 140 can begin to refuse requests after receipt of a predetermined number of bad requests. However, increase delegation or attempts to delegate generally result in efficient computation.

Turning attention back to FIG. 2, any computation that is rolled back by a data provider component 130 can be handled by the fallback execution component 240. However, once informed of a capability deficiency or roll back, the fallback execution component 240 can be configured to distribute all or a portion of work to another data source 140 for purposes of efficient execution.

Further yet, the query processor component 110 includes a cache component 250 configured to facilitate execution based on saved data, information or the like. For example, the cache component 250 can locally cache previously acquired data for subsequent utilization. Further, preemptive caching can be employed to pre-fetch data predicted to be likely to be employed. For example, a query can be expanded to return additional data. Further yet, the cache component 250 can generate stored procedures, or the like, with respect to a remote execution environment to enable expeditious access to popular data. Still further yet, the cache component 250 can store information regarding execution errors or failures to enable generation of subsequent execution strategies to consider this information.

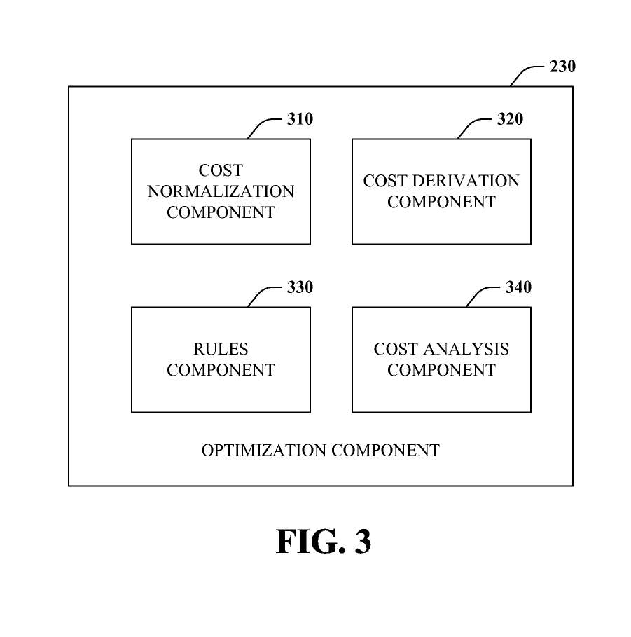

Turning attention to FIG. 3, a representative optimization component 230 is depicted in further detail. As shown, the optimization component 230 includes cost normalization component 310. Since the subject system concerns heterogeneous data sources, a standard, or canonical, cost model can be employed to allow for comparison between multiple data models/schema, or the like. In other words, cost information in a first data-source-specific format can be translated into a second standard format to enable reasoning over different sources at the same time. The cost normalization component 310 maps costs received, retrieved, or otherwise determined or infer about a data source to a standard cost representation. For example, latency and throughput metrics can be different between data sources and normalized to a standard form by the cost normalization component 310 to allow an “apples to apples” comparison of costs across data sources.

Cost derivation component 320 can be configured to generate additional cost information derived from known cost information. More specifically, a cost model can be derived from a weighted computation of multiple factors including, but not limited to, time, monetary cost per compute cycle, monetary cost per data transmission, or fidelity (e.g., loss or maintenance of information). Further, constraints can be supported with respect to multiple factors, or different cost models, for instance to allow a balance to be determined For example, a constraint can specify the least monetary expense that allows execution to complete within the next fifteen minutes.

Rules component 330 can be configured to apply a set of one or more optimization rules to applicable portions of a program to generate multiple equivalent programs or in other words candidate programs. Such rules can be somewhat speculative since it is not known which candidate is best. For example, it is not known whether it is best to use an indexed join versus a sort-merge join versus a nested loop join. Further, it unknown whether pulling data from one source and pushing the data to another source is better than pulling both data sets locally, for instance.

Cost analysis component 340 is configured to compute expected costs associated with each equivalent candidate program and identify one of the candidates as a function of the computed costs. More specifically, the cost analysis component 340 can be configured to analyze the efficiency of an equivalent candidate program based a cost model and select the most efficient candidate program, and thus an execution strategy.

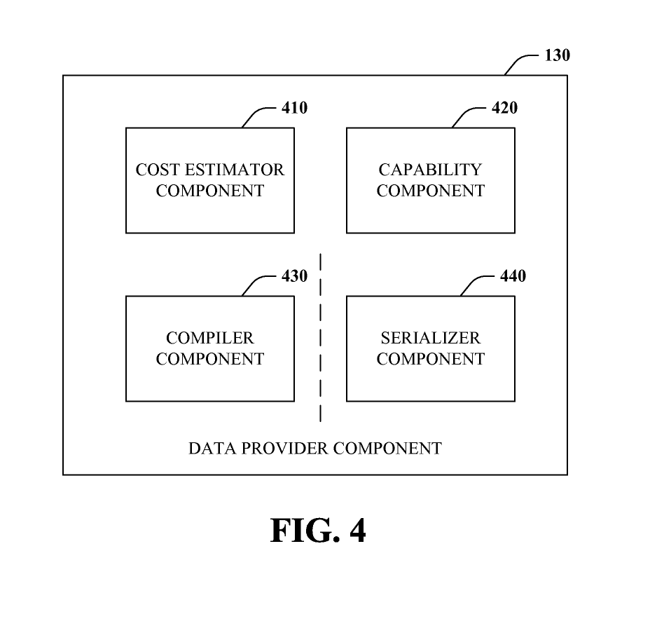

Turning attention to FIG. 4, a representative data-provider component 130 is illustrated in further detail. As previously mentioned, the data provider component 130 can provide a bridge between the query processor component 110 as well as the program 120, and particular data sources 140. Included is cost estimator component 410 and capability component 420.

The cost estimator component 410 can be configured to provide estimates of expected costs associated with interaction with a particular data source. In accordance with one embodiment, the cost estimator component 410 can request cost information from a data source associated system. For example, a database management system maintains cost information and execution plans that can be returned upon request. Additionally or alternatively, the cost estimator component can observe historical interactions with a data source and record information about interactions. This recorded information can then be analyzed to determine or infer cost estimates corresponding to latency, response time, etc.

The capability component 420 can be configured to identify data source capabilities. Similar to the cost estimator component 410, two embodiments can be employed. First, the capability component 420 can request identification capabilities from a data source and/or associated system, where enabled. Additionally or alternatively, the capability component 420 can observe and analyze interactions with a data source to determine or infer source capabilities.

The data provider component 130 can also facilitate interaction with a variety of different sources including those with different data retrieval capabilities. For example, with respect to queryable data sources like databases that can execute queries, compiler component 430 is configured to transform a program or portion thereof from a standard form to a form acceptable by, or native to, a data source. Subsequently, the program can be provided to a data source and executed thereby. For example, a program expression can be transformed to a structured query language and provided for execution over a relational database. As per non-queryable data sources that cannot execute queries, such as text, comma separated value files, and hypertext markup language (HTML) source, data can be acquired, for example, with serializer component 440. The serializer component 440 is configured to facilitate serialization and deserialization to enable data to be retrieved and operations executed over the data. For example, identified data can be serialized, transmitted to the data provider component 130, and de-serialized for use. Further, such data can be serialized to facilitate transmission for remote execution.

It is to be appreciated that all or portions of a program can be distributed to any computational engine or the like not just a query processor. Accordingly, the compiler component 430 can target any computational engine. By way of example, and not limitation, consider a situation where a program includes matrix computations. In this instance, a query processor associated with a relational database is likely not the best choice to execute the program. Rather, an engine that specializes in high-performance scientific computation would be a better target.

Furthermore, the query processor component 110, or like computational engine, can exploit redundant data. Often the identical data can be housed in multiple data stores. Previously, this description focused on determining an execution strategy based on costs including the cost of interacting with data stores and potentially selecting a single data store that is the least expensive. However, another approach can also be employed in which data is requested from multiple data stores and used from the first store to return the data. For example, data can be requested from the two least expensive sources. Data received first can be utilized while other data can be ignored or utilized in a comparison to verify receipt of correct data, for example.

The aforementioned systems, architectures, environments, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push or pull model. The components may also interact with one or more other components not specifically described herein for the sake of brevity, but known by those of skill in the art.

Furthermore, various portions of the disclosed systems above and methods below can include or consist of artificial intelligence, machine learning, or knowledge or rule-based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example and not limitation, the query processor component 110 can utilize such mechanisms to determine or infer an execution strategy.

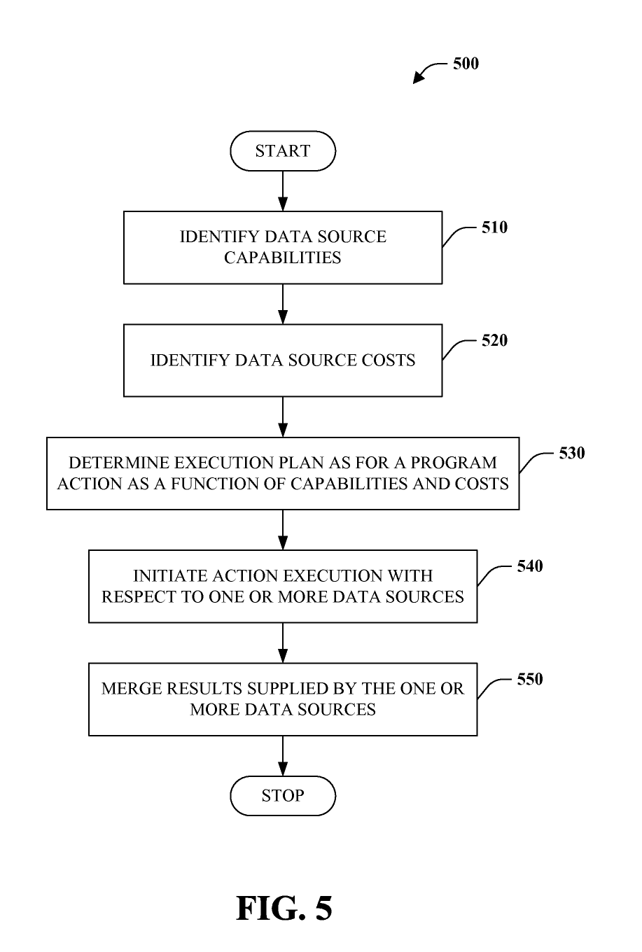

In view of the exemplary systems described supra, methodologies that may be implemented in accordance with the disclosed subject matter will be better appreciated with reference to the flow charts of FIG. 5-9. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described hereinafter.

FIG. 5 illustrates a method 500 of efficiently executing a program that interacts with data from multiple sources. At reference numeral 510, capabilities of a plurality of data sources and/or associated systems are identified. At numeral 520, data source costs are identified. For example, capability and cost information can be requested from data providers associated with respective data sources. At reference 530, an execution plan, or strategy, for a program is determined dynamically as a function of capabilities and costs. Execution of an action can be subsequently initiated with respect to one or more data sources based on the execution plan, at numeral 540. At reference numeral 550, results supplied by the one or more data sources are merged, as needed, to produce a final result.

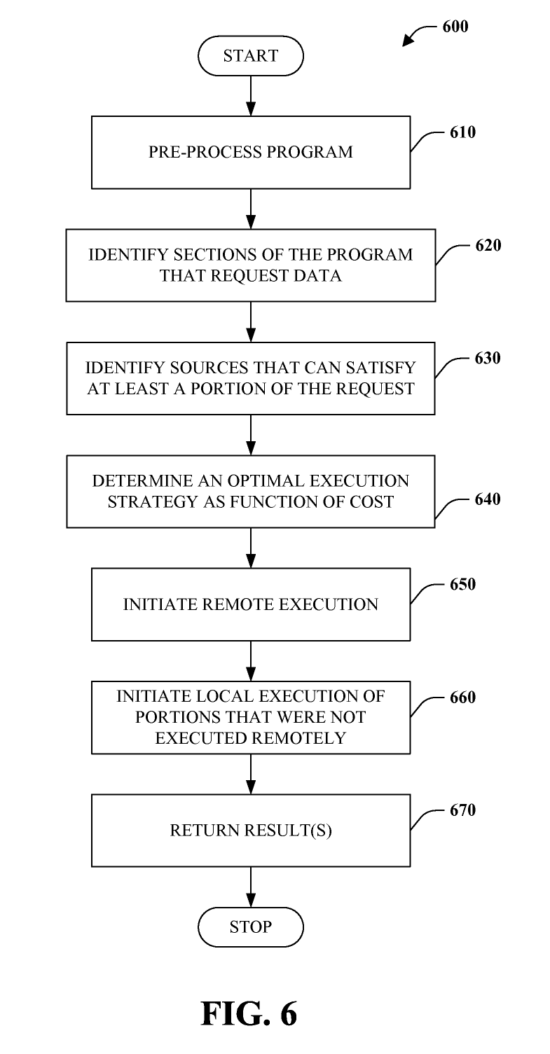

FIG. 6 depicts a method 600 of executing a program that interacts with data from multiple sources. At reference numeral 610, a program or portions thereof associated with data consumption can be pre-processed. In other words, the program can be mapped from a first form to a second standard form. In one particular embodiment of normalization, program functions, operations, and the like can include descriptions of themselves such as how they are invoked and their input arguments to enable subsequent distribution and remote execution by a query processor, for example. Further, pre-processing can be employed to transform the program into a more efficient program. For example, filters can be moved to operate before a join operation to minimize the amount of data being joined. At numeral 620, portions, or sections, of the program that request data from data sources are identified. At numeral 630, sources are identified that can satisfy at least a portion of the request. Note that more than one source may be able to satisfy a request or portion thereof At reference 640, an optimal execution strategy is determined as a function of cost, in one instance dynamically at runtime. In other words, a strategy can be selected for most efficiently executing the program including where the program will be executed. At reference numeral 650, remote execution can be initiated in accordance with the strategy. At numeral 660, local execution is initiated of one or more portions of the program that are not executed remotely. At reference numeral 670, results acquired from different sources are combined appropriately and returned. In accordance with one embodiment, a subset of results can be returned in a preview.

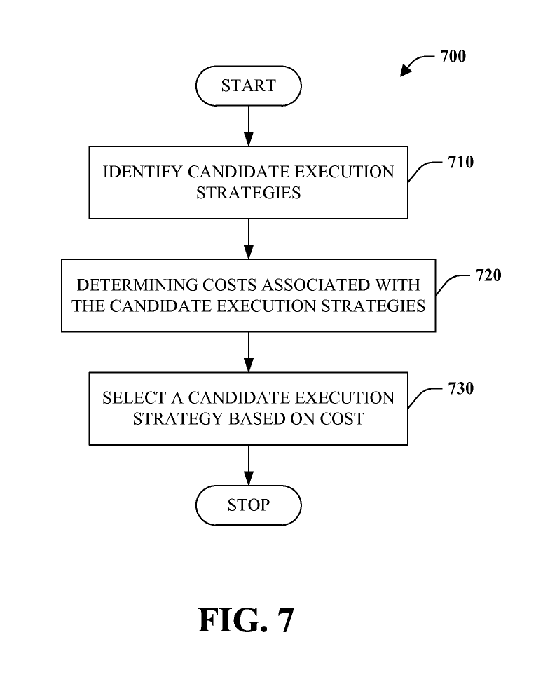

FIG. 7 illustrates a method 700 of cost-based program optimization. At reference numeral 710, candidate execution strategies are identified. Such strategies can be identified by speculatively applying a set of optimization rules to applicable parts of a program, thereby generating multiple equivalent programs or candidate programs. At numeral 720, costs associated with candidate execution strategies, and, more specifically, candidate programs are determined Such costs can be acquired from a data source or associated system, or determined or inferred from previous interactions. At reference numeral 730, a candidate execution strategy is selected as a function of cost. In accordance with one aspect, a standard cost model can be employed that allows comparison of costs between heterogeneous sources (e.g., different data models/schemas). Here, a cost model refers to an entity that abstractly describes the cost of interaction with data. For example, a time-based list-cost model includes the cost to initially create a list, and a per item cost to retrieve items in the list. Further, it is to be appreciated that a cost model derived from a weighted computation of multiple factors can be employed.

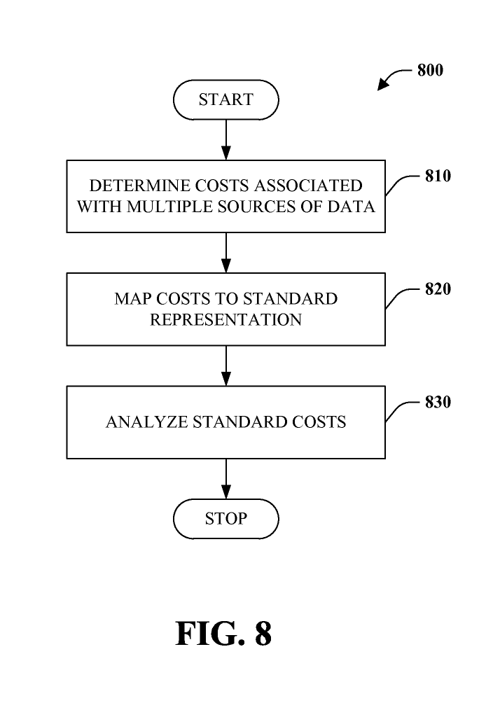

FIG. 8 is a flow chart diagram that depicts a method 800 of cost analysis over multiple heterogeneous sources of data. At numeral 810, a determination is made as to costs associated with multiple sources of data. Such costs can be represented differently for each different data source. At reference numeral 820, the costs can be mapped, or transformed, to a standard representation common to all sources of data. The standardized costs can then be analyzed at numeral 830, for example to determine an efficient execution strategy.

In one instance, aspects of the disclosure can be employed with respect to a data integration tool. The tool can be utilized to acquire data from multiple heterogeneous sources and perform data shaping, or, in other words, data manipulation, transformation, or filtering. By way of example and not limitation, an information worker (IW) can employ an application of choice such as a spreadsheet application, and from there the tool provides the information worker a new experience for acquiring and shaping data the results of which they can then import into their application of choice and/or export elsewhere.

As used herein, the terms “component” and “system,” as well as forms thereof are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner It is to be appreciated a myriad of additional or alternate examples of varying scope could have been presented, but have been omitted for purposes of brevity.

As used herein, the term “inference” or “infer” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

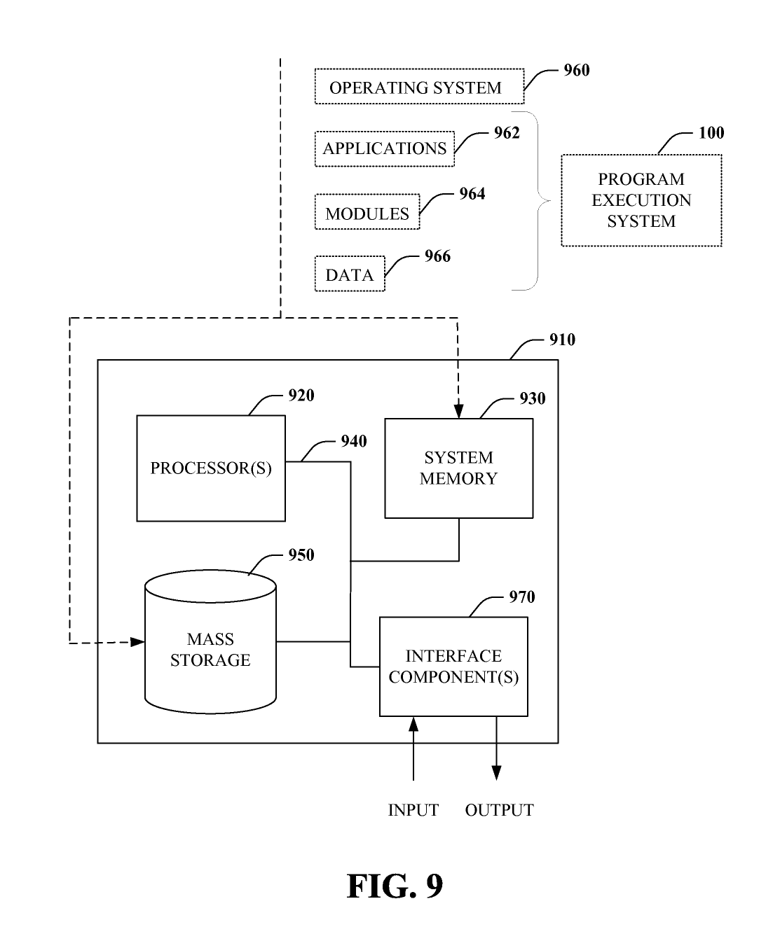

In order to provide a context for the claimed subject matter, FIG. 9 as well as the following discussion are intended to provide a brief, general description of a suitable environment in which various aspects of the subject matter can be implemented. The suitable environment, however, is only an example and is not intended to suggest any limitation as to scope of use or functionality.

While the above disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. Aspects can also be practiced in distributed computing environments where tasks are performed by remote processing devices that are linked through a communications network. However, some, if not all aspects of the claimed subject matter can be practiced on stand-alone computers. In a distributed computing environment, program modules may be located in one or both of local and remote memory storage devices.

With reference to FIG. 9, illustrated is an example general-purpose computer 910 or computing device (e.g., desktop, laptop, server, hand-held, programmable consumer or industrial electronics, set-top box, game system . . . ). The computer 910 includes one or more processor(s) 920, memory 930, system bus 940, mass storage 950, and one or more interface components 970. The system bus 940 communicatively couples at least the above system components. However, it is to be appreciated that in its simplest form the computer 910 can include one or more processors 920 coupled to memory 930 that execute various computer executable actions, instructions, and or components stored in memory 930.

The processor(s) 920 can be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 920 may also be implemented as a combination of computing devices, for example a combination of a DSP and a microprocessor, a plurality of microprocessors, multi-core processors, one or more microprocessors in conjunction with a DSP core, or any other such configuration.

The computer 910 can include or otherwise interact with a variety of computer-readable media to facilitate control of the computer 910 to implement one or more aspects of the claimed subject matter. The computer-readable media can be any available media that can be accessed by the computer 910 and includes volatile and nonvolatile media, and removable and non-removable media. By way of example, and not limitation, computer-readable media may comprise computer storage media and communication media.

Computer storage media includes volatile and nonvolatile, removable and non-removable media implemented in any method or technology for storage of information such as computer-readable instructions, data structures, program modules, or other data. Computer storage media includes, but is not limited to memory devices (e.g., random access memory (RAM), read-only memory (ROM), electrically erasable programmable read-only memory (EEPROM) . . . ), magnetic storage devices (e.g., hard disk, floppy disk, cassettes, tape . . . ), optical disks (e.g., compact disk (CD), digital versatile disk (DVD) . . . ), and solid state devices (e.g., solid state drive (SSD), flash memory drive (e.g., card, stick, key drive . . . ) . . . ), or any other medium which can be used to store the desired information and which can be accessed by the computer 910.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 930 and mass storage 950 are examples of computer-readable storage media. Depending on the exact configuration and type of computing device, memory 930 may be volatile (e.g., RAM), non-volatile (e.g., ROM, flash memory . . . ) or some combination of the two. By way of example, the basic input/output system (BIOS), including basic routines to transfer information between elements within the computer 910, such as during start-up, can be stored in nonvolatile memory, while volatile memory can act as external cache memory to facilitate processing by the processor(s) 920, among other things.

Mass storage 950 includes removable/non-removable, volatile/non-volatile computer storage media for storage of large amounts of data relative to the memory 930. For example, mass storage 950 includes, but is not limited to, one or more devices such as a magnetic or optical disk drive, floppy disk drive, flash memory, solid-state drive, or memory stick.

Memory 930 and mass storage 950 can include, or have stored therein, operating system 960, one or more applications 962, one or more program modules 964, and data 966. The operating system 960 acts to control and allocate resources of the computer 910. Applications 962 include one or both of system and application software and can exploit management of resources by the operating system 960 through program modules 964 and data 966 stored in memory 930 and/or mass storage 950 to perform one or more actions. Accordingly, applications 962 can turn a general-purpose computer 910 into a specialized machine in accordance with the logic provided thereby.

All or portions of the claimed subject matter can be implemented using standard programming and/or engineering techniques to produce software, firmware, hardware, or any combination thereof to control a computer to realize the disclosed functionality. By way of example and not limitation the efficient program execution system 100, or portions thereof, can be, or form part, of an application 962, and include one or more modules 964 and data 966 stored in memory and/or mass storage 950 whose functionality can be realized when executed by one or more processor(s) 920.

In accordance with one particular embodiment, the processor(s) 920 can correspond to a system on a chip (SOC) or like architecture including, or in other words integrating, both hardware and software on a single integrated circuit substrate. Here, the processor(s) 920 can include one or more processors as well as memory at least similar to processor(s) 920 and memory 930, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the efficient program execution system 100, or portions thereof, and/or associated functionality can be embedded within hardware in a SOC architecture.

The computer 910 also includes one or more interface components 970 that are communicatively coupled to the system bus 940 and facilitate interaction with the computer 910. By way of example, the interface component 970 can be a port (e.g., serial, parallel, PCMCIA, USB, FireWire . . . ) or an interface card (e.g., sound, video . . . ) or the like. In one example implementation, the interface component 970 can be embodied as a user input/output interface to enable a user to enter commands and information into the computer 910 through one or more input devices (e.g., pointing device such as a mouse, trackball, stylus, touch pad, keyboard, microphone, joystick, game pad, satellite dish, scanner, camera, other computer . . . ). In another example implementation, the interface component 970 can be embodied as an output peripheral interface to supply output to displays (e.g., CRT, LCD, plasma . . . ), speakers, printers, and/or other computers, among other things. Still further yet, the interface component 970 can be embodied as a network interface to enable communication with other computing devices (not shown), such as over a wired or wireless communications link.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

What is claimed is:

1. A method of facilitating data access, comprising:
employing at least one processor configured to execute computer-executable instructions stored in memory to perform the following acts:
generating an execution strategy for a program that acquires data from multiple heterogeneous data sources during program execution as a function of data source capability and cost.

2. The method of claim 1 further comprises determining the cost as a function of a cost model standard across the heterogeneous data sources.

3. The method of claim 2, determining the cost from a weighted computation of multiple factors.

4. The method of claim 1 further comprises acquiring the cost from a data source in response to a request for the cost.

5. The method of claim 1 further comprises determining the cost as a function of data source interaction.

6. The method of claim 1 further comprises locally executing at least a portion of the program.

7. The method of claim 1 further comprises transforming the program from a first form to a second standard form.

8. The method of claim 7 further comprises applying one or more optimizations to the standard form of the program.

9. The method of claim 1 further comprises initiating distribution of at least a subset of the program on one of the heterogeneous data sources.

10. A system that facilitates program execution, comprising:
a processor coupled to a memory, the processor configured to execute the following computer-executable components stored in the memory:
a first component configured to generate a strategy for execution of a query specified over multiple heterogeneous data sources based on data source capability and cost.

11. The system of claim 10, the first component is configured to generate the strategy lazily at runtime.

12. The system of claim 10 further comprises a second component configured to execute at least a portion of the query locally.

13. The system of claim 10 further comprises a second component configured to request at least one of the capability or the cost from one of the data sources.

14. The system of claim 10 further comprises a second component configured to infer the capability or the cost as a function of historical interaction with one of the data sources.

15. The system of claim 10 further comprises a second component configured to normalize the cost across two or more of the heterogeneous data sources.

16. The system of claim 10 further comprises a second component configured to distribute portions of the query to one or more of the heterogeneous data sources in accordance with the strategy.

17. A computer-readable storage medium having instructions stored thereon that enables at least one processor to perform the following acts:
determining an execution strategy for a computer executable program, configured to merge data acquired from multiple heterogeneous data sources, dynamically as a function of one or more capabilities of the data sources or one or more costs of interacting with the data sources.

18. The computer-readable storage medium of claim 17 further comprising initiating distribution of at least a portion of the program to one of the data sources for execution in accordance with the execution strategy.

19. The computer-readable storage medium of claim 18 further comprising initiating local execution of the at least a portion of the program upon execution failure.

20. The computer-readable storage medium of claim 17 further comprising initiating local execution of at least a portion of the program in accordance with the execution strategy.
